(19) United States
(12) Patent Application Publication
(10) Pub. No.: US 2020/0232359 A1
(43) Pub. Date: Jul. 23, 2020

(54) EXHAUST SYSTEM FOR AN INTERNAL COMBUSTION ENGINE AND METHOD FOR OPERATING THE SAME

(71) Applicant: VOLKSWAGEN AKTIENGESELLSCHAFT, Wolfsburg (DE)

(72) Inventors: Michael KAACK, Rötgesbüttel (DE); Stefan PAUKNER, Wolfsburg (DE); Falk-Christian BARON VON CEUMERN-LINDENSTJERNA, Braunschweig (DE); Tolga BOZALP, Berlin (DE)

(73) Assignee: VOLKSWAGEN AKTIENGESELLSCHAFT, Wolfsburg (DE)

(21) Appl. No.: 16/743,686

(22) Filed: Jan. 15, 2020

(30) Foreign Application Priority Data
Jan. 21, 2019 (DE) 10 2019 101 394.1

(51) Int. Cl. F01N 3/027; B01D 53/94; F01N 3/20; F01N 11/00

(52) U.S. Cl. CPC F01N 3/027; B01D 53/9445; F01N 3/2033; F01N 2250/06; F01N 3/2013; F01N 2240/14; F01N 2240/16; F01N 11/002

(57) ABSTRACT

An exhaust gas system for an internal combustion engine, comprising a first exhaust emission control device close to the engine and a second exhaust emission control device remote from the engine. The second exhaust emission control device is heatable by a combination of an upstream burner and an electric heating device. For heating the exhaust emission control devices after an engine start, the internal combustion engine is operated with at least one engine-internal measure for raising the exhaust gas temperature, and the burner and the electric heating device are activated at the same time or offset in time for heating the second exhaust emission control device. A mixed gas entering the second exhaust emission control device is set to a stoichiometric lambda value. The invention allows accelerated heating of the exhaust emission control devices, and thus, a reduction in starting emissions.

### CROSS REFERENCE TO RELATED APPLICATION

This application claims priority from German Patent Application No. 10 2019 101 394.1, filed Jan. 21, 2019, the contents of which are incorporated herein by reference.

### FIELD OF THE INVENTION

The invention relates to an exhaust gas system for an internal combustion engine and a method for operating the exhaust gas system, when a low-temperature state is present, for heating exhaust emission control devices of the exhaust gas system.

### BACKGROUND OF THE INVENTION

Catalytic exhaust emission control devices, which are used in exhaust gas systems of internal combustion engines in vehicles, require an operating temperature in order to be effective. The operating temperature is characterized in particular by a catalytic converter-specific light-off temperature, which is defined as the temperature above which 50% of the incoming emissions are converted. Since catalytic exhaust emission control devices generally have not yet reached their light-off temperature after a cold start of the internal combustion engine, various measures are known for raising the exhaust gas temperature in order to achieve rapid heating. Examples include ignition angle retardation, secondary air feed in combination with an understoichiometric fuel-air mixture of the internal combustion engine, electric heating, late fuel injection and post-injection, and installation of burners in the exhaust system. These methods allow only limited heating power, and are associated with certain operating conditions that limit their usability.

An exhaust gas system having an SCR catalytic converter is known from EP 2646 662 B1, in which a bypass line branches off from the exhaust duct upstream from a urea injector, and via the bypass line a subflow of the exhaust gas enters a partial volume of the SCR catalytic converter that is separate from the remaining volume of the SCR catalytic converter. Situated in the bypass line is a heating device via which the subflow of the exhaust gas may be heated before entering the SCR catalytic converter. Quicker light-off may thus be achieved in a partial volume of the SCR catalytic converter. The heating device may be designed as an electric heater, a burner, or the like. U.S. Pat. No. 9,784,157 B2 describes an exhaust gas system having an HC-SCR catalytic converter that catalytically reacts nitrogen oxides in the presence of a hydrocarbon HC, such as diesel fuel or gasoline, that is injected upstream from the HC-SCR catalytic converter. A heating device for heating the exhaust gas stream is connected upstream from the HC-SCR catalytic converter in order to regenerate it by removal of hydrocarbon deposits. The heating device may be designed as a combination of a diesel oxidation catalytic converter (DOC) with upstream hydrocarbon injection, so that the injected hydrocarbon is exothermically combusted on the DOC. Instead of the DOC, the injected hydrocarbon may be exothermically combusted in a burner in the exhaust duct. According to another embodiment, the heating device is designed in the form of an electric resistance heater.

The object of the invention is to provide an exhaust gas system that allows the operating temperatures of the catalytic converters to be reached more quickly, thereby reducing the starting emissions.

### SUMMARY OF THE INVENTION

This object is achieved by an exhaust gas system for an internal combustion engine and a method for operating same, having the features of the independent claims. Further preferred embodiments of the invention result from the other features set forth in the subclaims.

The exhaust gas system according to the invention includes a first exhaust emission control device through which an exhaust gas of the internal combustion engine may flow, and a second exhaust emission control device, situated in the exhaust gas flow path downstream from the first exhaust emission control device, through which exhaust gas may flow. The second exhaust emission control device has an electric heating device for heating the second exhaust emission control device. The exhaust gas system also includes a burner, situated in the exhaust gas flow path downstream from the first exhaust emission control device and upstream from the second exhaust emission control device, that is configured for being operated with a fuel and an oxidative gas stream in order to heat the gas stream by combustion of the fuel and supplying it to the second exhaust emission control device.

Very rapid heating of the second exhaust emission control device is possible by providing a combination of two heating measures, comprising the burner and the electric heating device, for heating the second exhaust emission control device, which is situated relatively remote from the engine. At least a small catalytic converter volume is activated very quickly by the electric heating device. The further volume together with the burner heating may then be heated and activated with high heating power and low emissions due to the exothermic activity of this small catalytic converter volume. As a result of the additive heating power, the second exhaust emission control device may be heated to its light-off temperature very quickly, even with a large catalytic converter volume, so that starting emissions during a cold start are reduced. Since these heating measures function external to the engine, i.e., independently of the operating mode of the internal combustion engine, the internal combustion engine may be operated as desired in this phase, for example also with high-level starting dynamics. Due to the high heating power, the second exhaust emission control device, despite its installation position remote from the engine, for example at an underbody position of the vehicle, and its relatively large volume, may reach its light-off temperature even before the first exhaust emission control device close to the engine, and may thus be the first to attain its conversion power. Although the thermal stress on the second exhaust emission control device caused by the two heating measures is comparatively high, this may be tolerated due to the fact that in routine driving operations, even under high loads, the thermal stress at the installation position remote from the engine is low. Thus, the aging stability of the second exhaust emission control device is not significantly impaired, despite the high energy input during the cold start. In addition, it is possible to vary the heating power to the second exhaust emission control device as necessary. Lastly, the burner allows the combustion air ratios (lambda value) to be individually set via the second exhaust emission control device, which is independent of the engine lambda regulation via the first exhaust emission control device. This allows high conversion power for both exhaust emission control devices.

Within the scope of the present patent application, the term “exhaust emission control device” is understood to mean a device that is able to reduce at least one exhaust gas component from an internal combustion engine exhaust gas, so that the concentration of this exhaust gas component in the emissions emitted to the environment is reduced. In particular, this involves a chemical-catalytic reaction of the exhaust gas component in question. The exhaust emission control device preferably includes a catalytically active component in the form of a catalytic coating that requires a minimum temperature (light-off temperature) in order to function.

In one preferred embodiment of the invention, it is provided that the first exhaust emission control device is situated at a position close to the engine, in particular in such a way that an exhaust gas path length between the cylinder outlet of the internal combustion engine and the entry surface of the first exhaust emission control device is at most 50 cm, in particular at most 40 cm, preferably at most 30 cm. Due to such an arrangement close to the engine, it is ensured that the first exhaust emission control device is acted on by very high exhaust gas temperatures, so that the first exhaust emission control device may be quickly heated to its light-off temperature after an engine start, and this temperature level may be maintained during further operation.

The second exhaust emission control device is preferably situated at an underbody position remote from the engine, in particular in such a way that an exhaust gas path length between the cylinder outlet of the internal combustion engine and the entry surface into the second exhaust emission control device is at least 80 cm, in particular at least 100 cm, preferably at least 120 cm. The arrangement at an underbody position has the advantage that the available installation space is larger here than in the engine compartment close to the engine, so that even large catalytic converter volumes may be accommodated. In addition, due to the lower exhaust gas temperatures at this position, the thermal stress on the second exhaust emission control device, and thus its aging, is reduced. For this reason, the second exhaust emission control device generally has a larger volume than the first exhaust emission control device.

According to one embodiment of the invention, the first exhaust emission control device is a three-way catalytic converter. Three-way catalytic converters have a catalytic coating that is able to convert the exhaust gas components comprising hydrocarbons, carbon monoxide, and nitrogen oxides in a stoichiometric exhaust gas composition with a high conversion rate. Three-way catalytic converters are therefore advantageous in gasoline engines. Alternatively, the first exhaust emission control device is a four-way catalytic converter. This is understood to mean a particulate filter, in particular a gasoline engine particulate filter, having a three-way catalytic coating. Thus, the four-way catalytic converter is able to also reduce particulate emissions in addition to the three exhaust gas components mentioned above, and is likewise suitable for gasoline engines.

The second exhaust emission control device is also preferably a three-way catalytic converter that is characterized by the same catalytic properties and advantages as described for the first exhaust emission control device.

In another preferred embodiment of the invention, it is provided that the exhaust gas system also includes a measuring device, situated upstream from the first exhaust emission control device, for measuring an oxygen content of the exhaust gas, and/or a measuring device, situated downstream from the first exhaust emission control device and downstream from the burner, for measuring an oxygen content of the exhaust gas, both measuring devices preferably being designed as lambda sensors. Both measuring devices are preferably provided. Particularly rapid regulation of the internal combustion engine lambda value may take place via the first measuring device. The second measuring device connected downstream from the first exhaust emission control device is used on the one hand for function monitoring of the first exhaust emission control device, and on the other hand for likewise regulating the internal combustion engine lambda value.

According to another preferred embodiment, the exhaust gas system also includes a third measuring device, situated downstream from the burner and upstream from the second exhaust emission control device (i.e., between the burner and the second exhaust emission control device), for measuring an oxygen content of the exhaust gas, and/or a measuring device, situated downstream from or in the second exhaust emission control device, for measuring an oxygen content of the exhaust gas, both measuring devices preferably being designed as lambda sensors. Both measuring devices are preferably provided. The third measuring device allows precise lambda regulation of the burner-side lambda value. The fourth measuring device situated downstream from or in the second exhaust emission control device is used for function monitoring of the second exhaust emission control device.

In addition to the first or second exhaust emission control device, further catalytic the mechanical exhaust gas emission control components may be installed in the exhaust gas system. In particular, the exhaust gas system may include a particulate filter, in particular a gasoline engine particulate filter, that is situated downstream from the first or the second exhaust emission control device. A reduction in particulate emissions is thus achieved. In addition, downstream from the second exhaust emission control device a further three-way catalytic converter or four-way catalytic converter may be situated which results in a catalytic reduction in hydrocarbons, carbon monoxide, and nitrogen oxides as well as mechanical retention of particles. The volume of the upstream second exhaust emission control device may thus be selected to be small compared to the downstream three-way or four-way catalytic converter, so that the second exhaust emission control device may be heated to operating temperature even more quickly.

In a further aspect, the invention provides a method for operating the exhaust gas system according to the invention when a low-temperature state is present, for example after a cold start of the internal combustion engine, if the first and/or second exhaust emission control device have/has not yet reached their/its operating temperature. The method comprises the steps: operating the internal combustion engine using an engine-internal measure for raising the exhaust gas temperature; and activating the burner and the electric heating device of the second exhaust emission control device, wherein the internal combustion engine and the burner are each operated with a lambda value in such a way that a mixed gas, composed of internal combustion engine exhaust gas and burner exhaust gas, entering the second exhaust emission control device is stoichiometric with λₘ=1.

The first exhaust emission control device is brought to operating temperature primarily by the engine-internal heating measure. The two engine-external heating measures are used to quickly heat the second exhaust emission control device. The engine-internal heating measure and the two engine-external heating measures may be started at the same time, or offset in time in any sequence. In particular, the electric heating of the second exhaust emission control device may be started with a certain offset in time before the burner is activated. This ensures that the burner emissions are reacted on a partial volume of the second exhaust emission control device that is activated by the electric heating.

Essentially complete reaction of the relevant exhaust gas components is ensured by adjusting the stoichiometric mixed gas. This may take place via two alternative approaches.

In a first variant, the internal combustion engine (in particular immediately after starting the engine) is operated with a stoichiometric lambda value of λₑ=1, and the burner is operated with a stoichiometric lambda value of λ_{b}=1. Optimal catalytic conversion power is thus achieved on both exhaust emission control devices.

Alternatively, the internal combustion engine is operated with a slightly rich lambda value of λₑ<1, and the burner is operated with a slightly lean lambda value of λ_{b}<1, in such a way that the mixed gas is stoichiometric with λₘ=1. This has the advantage that the particulate emissions of the burner during the slightly lean operation are reduced, and the increased content of CO and HC in the exhaust gas results in further acceleration in the heating of the second exhaust emission control device.

The engine-internal heating measure for raising the exhaust gas temperature may include, for example, an adjustment of the ignition angle in the retarded direction, thereby reducing the efficiency of the engine and increasing the exhaust gas temperature. In addition, a delay in the fuel injection or additional fuel injection may take place after ignition top dead center, or an exhaust gas recirculation rate may be adjusted, in particular reduced.

The particular heating measure is preferably ended when the exhaust emission control device in question has reached its operating temperature.

The method is carried out in particular using an electronic control device containing an appropriate algorithm in computer-readable form as well as appropriate characteristic maps, etc.

Unless stated otherwise in the individual case, the various embodiments described in the present patent application may advantageously be combined with one another.

### BRIEF DESCRIPTION OF THE DRAWINGS

The invention is explained below in exemplary embodiments, with reference to the associated drawings. In the figures:

FIG. 1 shows an internal combustion engine having an exhaust gas system according to a first embodiment of the invention;

FIG. 2 shows an internal combustion engine having an exhaust gas system according to a second embodiment of the invention;

FIG. 3 shows an internal combustion engine having an exhaust gas system according to a third embodiment of the invention;

FIG. 4 shows an internal combustion engine having an exhaust gas system according to a fourth embodiment of the invention;

FIG. 5 shows an internal combustion engine having an exhaust gas system according to a fifth embodiment of the invention;

FIG. 6 shows an internal combustion engine having an exhaust gas system according to a sixth embodiment of the invention; and

FIG. 7 shows an internal combustion engine having an exhaust gas system according to a seventh embodiment of the invention.

### DETAILED DESCRIPTION OF THE INVENTION

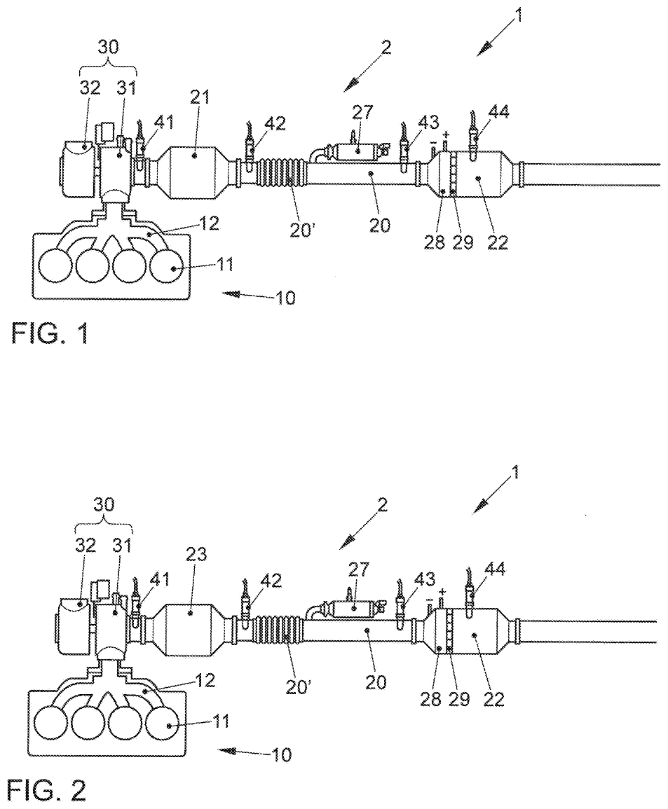

For a motor vehicle denoted overall by reference numeral 1, FIG. 1 shows only an internal combustion engine 10 with an exhaust gas system 2 connected thereto.

The internal combustion engine 10 in the present case is a spark ignition gasoline engine that is operable with gasoline, and that has four cylinders 11, for example. The exhaust gases of the cylinders are combined in an exhaust manifold 12 and supplied to the exhaust gas system 2, where they initially flow through an exhaust gas turbine 31 of an exhaust gas turbocharger 30 in order to drive a compressor 32 of the exhaust gas turbocharger 30, which is situated in an air supply tract (not illustrated in greater detail here) of the internal combustion engine 10. From the turbine 31, the exhaust gas flows into an exhaust duct 20 of the exhaust gas system 2.

The exhaust gas system 2 includes the exhaust duct 20, which has a section close to the engine and an underbody section that are connected to one another via a connecting piece 20′. Situated in the section of the exhaust duct 20 close to the engine is a first exhaust emission control device 21 designed as a three-way catalytic converter. The first exhaust emission control device 23 preferably has a metal support with a three-way catalytic coating that catalytically reacts the unburned hydrocarbons HC and carbon monoxide CO together with nitrogen oxides NOₓ, thus reducing these three exhaust gas components in the exhaust gas. An end-face side of the metal support on the inlet side is spaced apart from the gas outlets of the cylinders 11 by at most 50 cm, and is measured as the exhaust gas path length.

A second exhaust emission control device 22, likewise designed as a three-way catalytic converter, is situated in the underbody section of the exhaust duct 20. The second exhaust emission control device 22 has a substrate, preferably designed as a ceramic monolith, with a three-way catalytic coating that is similar or identical to the first exhaust emission control device 21. The second exhaust emission control device 22 has an electric heating device 28, which in the illustrated example is designed as a heating disc through which the exhaust gas may flow, is situated flatly against the end-face side of the substrate of the exhaust emission control device 22 on the inlet side, and is electrically heatable. The heating disc 28 is connected to the substrate of the exhaust emission control device 22 via support pins 29. A catalytically coated or uncoated support substrate may optionally be situated between the heating disc 28 and the substrate 22. The end-face side of the substrate of the second exhaust emission control device 22 on the inlet side is spaced apart from the gas outlets of the cylinders 11 by at least 80 cm, measured as the exhaust gas path length. Due to its arrangement at an underbody position of the vehicle 1, the second exhaust emission control device 22 is also referred to as an underbody catalytic converter.

The exhaust gas system 2 also has a burner 27 situated downstream from the first exhaust emission control device 21 and upstream from the second exhaust emission control device 22. The burner 27 is operable with a fuel and an oxidative gas stream, the fuel being oxidatively and exothermically combusted with the gas stream, thus heating the gas stream. The heated gas stream exits the burner 27 as burner exhaust gas, and is introduced into the exhaust duct 20 upstream from the second exhaust emission control device 22 and supplied to same. In the illustrated example, the oxidative gas stream is oxygen-containing air that is drawn in from the surroundings. The fuel may be any combustible hydrocarbon, such as gasoline, diesel fuel, ethane, methane, propane, butane, etc., or hydrogen or a mixture of same. For reasons of practicability, the fuel with which the internal combustion engine 10 is operated is used as fuel for the burner 27. By use of the burner 27 and the electric heating device 28, the second exhaust emission control device 22 may thus be selectively heated by the burner 27 or by the electric heating device 28, or by both at the same time.

The exhaust gas system 2 also has various measuring devices for measuring the oxygen content of the exhaust gas, which in particular may be designed as lambda sensors and situated at various positions in the exhaust duct 20. A first lambda sensor 41 is situated downstream from the turbine 31 and upstream from the first exhaust emission control device 21, and is preferably designed as a broadband lambda sensor to allow the lambda value to be accurately determined over a wide range and the engine combustion lambda to be regulated. A second lambda sensor 42, preferably designed as a jump lambda sensor (Nernst sensor), is situated downstream from the first exhaust emission control device 21 and upstream from the burner 27. An optional third lambda sensor 43, preferably designed as a jump lambda sensor, is situated downstream from the burner 27 and upstream from the second exhaust emission control device 22, and allows regulation of the combustion lambda of the burner 27. In the present example, a fourth lambda sensor 44 is situated within the second exhaust emission control device 22, but may also be situated downstream from the second exhaust emission control device 22.

The exhaust gas system 2 shown in FIG. 1 is preferably operated as follows in order to bring the exhaust emission control devices 21, 22 to operating temperature preferably quickly, for example after an engine start. The exhaust gas systems 2 illustrated in FIGS. 2 through 7 are correspondingly operated.

It is initially determined whether heating of the exhaust emission control devices 21, 22 is necessary. This may take place on the one hand by measuring the temperature using suitable temperature sensors, situated on the catalytic converter substrates, for example, wherein in particular measuring the temperature of the first exhaust emission control device 21 may be sufficient. Alternatively, the temperature may be estimated, for example by detecting the outside temperature and/or the duration of a period for which the internal combustion engine 10 is not operated. If the determined temperature is below a limiting temperature, which in particular corresponds to a light-off temperature of the first and/or second exhaust emission control device 21, 22, the presence of a low-temperature state is established.

If a low-temperature state is present, a heating operation takes place for heating the first and second exhaust emission control devices 21, 22. For this purpose, the internal combustion engine 10 is operated using at least one engine-internal measure for raising the exhaust gas temperature compared to normal operation. The at least one engine-internal measure includes, for example, ignition angle retardation with respect to a standard ignition angle, which is an efficiency-optimized ignition angle, for example, late fuel injection after injection top dead center, or the like. The raising of the exhaust gas temperature, induced in this way, results in a rapid increase in the temperature of the first exhaust emission control device 21.

At the same time or with a time offset with respect to the engine-internal measure for raising the exhaust gas temperature, the engine-external heating measures are activated. For this purpose, the burner 27 is put into operation by supplying it with air and fuel, so that the air is heated. The air heated in this way is led into the exhaust duct 20 upstream from the second exhaust emission control device 22 and mixes with the exhaust gas that has passed through the first exhaust emission control device 21, and enters the second exhaust emission control device 22. Concurrently with the operation of the burner 27, the electric heating device 28 of the second exhaust emission control device 22 is activated. Very quick heating of the second exhaust emission control device 22 is achieved by the parallel operation of the burner 27 and the electric heating device 28.

During the engine-internal and engine-external heating measures, the internal combustion engine 10 and the burner 27 are operated in such a way that a mixed gas entering the second exhaust emission control device 22 is stoichiometric, with λₘ=1 as a setpoint variable. In this way, optimal catalytic conversion power from HC, CO and NOₓ is achieved in the rear three-way catalytic converter 22 immediately upon reaching its light-off temperature.

To achieve a stoichiometric mixed gas with λₘ=1, in a first embodiment of the method the internal combustion engine 10 is operated with a stoichiometric air-fuel mixture of λₑ=1 (setpoint variable), and the burner 27 is operated with a stoichiometric air-fuel mixture of A_{b}=1 (setpoint variable). In this way, both exhaust emission control devices 21, 22 are acted on with a stoichiometric exhaust gas, so that they both deliver optimal conversion power immediately after being activated. The internal combustion engine air-fuel mixture λₑ is regulated via a first lambda control loop by means of the first lambda sensor 41. The air-fuel mixture λ_{b} of the burner 27 is regulated via a second, separate lambda control loop by means of the third (or fourth) lambda sensor 42 and 43 (or 44).

According to a second embodiment of the method, the internal combustion engine 10 is operated slightly rich, for example with λₑ=0.9, and the burner 27 is operated slightly lean, in such a way that the mixed gas entering the second exhaust emission control device 22 is controlled stoichiometrically with λₘ=1. This results in the advantage that the components HC and CO, which are increasingly present in the slightly rich internal combustion engine exhaust gas, are exothermically reacted on the second exhaust emission control device 22, resulting in even more rapid heating of the second exhaust emission control device 22. (Due to the nonstoichiometric exhaust gas composition that enters the exhaust emission control device 21 close to the engine, there is hardly any conversion of HC and CO in the exhaust emission control device 21 close to the engine.) In addition, in the second embodiment of the method the total particulate emissions (measured as the particle number PN) are reduced, since with slightly lean operation the burner 27 emits fewer particles compared to stoichiometric operation. However, in this method the formation of ammonia in the first exhaust emission control device 21 under the slightly rich conditions may be disadvantageous, and may result in increased nitrogen oxides emissions in the start phase.

FIG. 2 shows a vehicle 1 having an internal combustion engine 10 and an exhaust gas system 2 connected thereto according to a second embodiment of the invention, wherein identical components are denoted by the same reference numerals as in FIG. 1 and are not explained again. The exhaust gas system 2 shown in FIG. 2 differs from FIG. 1 in that the first exhaust emission control device is designed as a four-way catalytic converter 23. This involves a particulate filter, in particular a gasoline engine particulate filter, for mechanical retention of particulate exhaust gas components; the filter substrate of the four-way catalytic converter has a three-way catalytic coating. In this way, the four-way catalytic converter 23 is able to reduce the four exhaust gas components comprising unburned hydrocarbons HC, carbon monoxide CO, nitrogen oxides NOₓ, and particulate emissions in the exhaust gas.

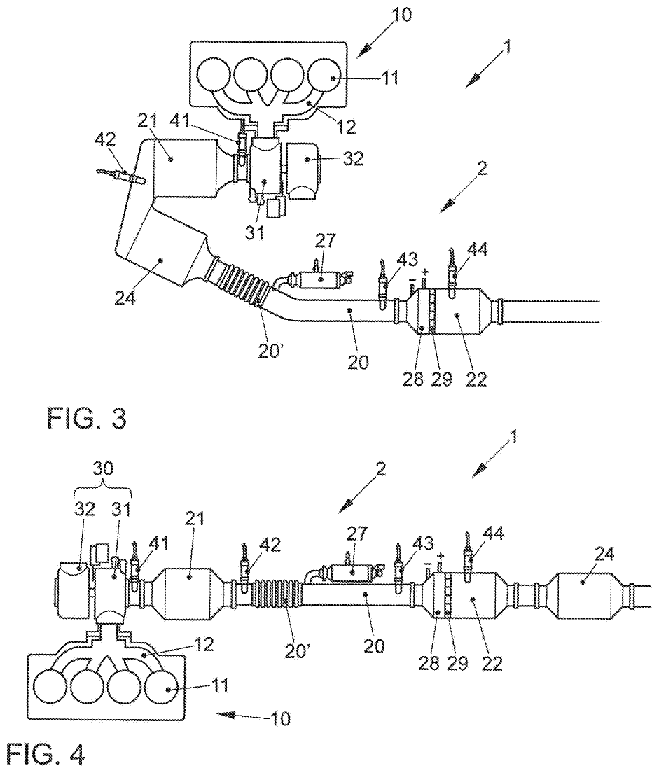

FIG. 3 shows a vehicle 1 having an internal combustion engine 10 and an exhaust gas system 2 connected thereto according to a third embodiment of the invention, wherein identical components are denoted by the same reference numerals as in FIG. 1 and are not explained again. The exhaust gas system 2 shown in FIG. 3 differs from FIG. 1 in that a gasoline engine particulate filter 24 close to the engine is connected downstream from the first exhaust emission control device 21 (three-way catalytic converter), wherein the three-way catalytic converter 21 and the gasoline engine particulate filter 24 are in particular situated on a shared catalytic converter housing. The three-way catalytic converter 21 essentially corresponds to that from FIG. 1. The gasoline engine particulate filter 24 is strictly a particulate filter for mechanical retention of particulate exhaust gas components, without a catalytic coating. In this way, the combination of the first exhaust emission control device 21 and the particulate filter 24, similar to the four-way catalytic converter 23 according to FIG. 2, is able to reduce the four exhaust gas components comprising unburned hydrocarbons HC, carbon monoxide CO, nitrogen oxides NOₓ, and particulate emissions in the exhaust gas. This variant has the advantage that the three-way catalytic converter 21 may include a metal substrate and thus has greater temperature stability. However, the space requirements are greater compared to the design from FIG. 2. However, a comparatively space-saving arrangement is made possible by designing the shared catalytic converter housing with a bend, so that the exhaust gas flow direction changes between the two components 21, 24.

FIG. 4 shows a vehicle 1 having an internal combustion engine 10 and an exhaust gas system 2 connected thereto according to a fourth embodiment of the invention, wherein identical components are denoted by the same reference numerals as in FIG. 1 and are not explained again. The exhaust gas system 2 shown in FIG. 4 differs from FIG. 1 in that an uncoated particulate filter 24 for mechanical retention of particulate exhaust gas components, in particular a gasoline engine particulate filter, is situated at an underbody position downstream from the electrically heated exhaust emission control device 22. The exhaust gas system 2 according to FIG. 4 is thus able to reduce the four exhaust gas components comprising unburned hydrocarbons HC, carbon monoxide CO, nitrogen oxides NOₓ, and particulate emissions in the exhaust gas. Since there is comparatively more installation space in the underbody area than close to the engine, it is often possible to more easily accommodate the particulate filter 24 or other components at this location than in the engine compartment (as illustrated in FIG. 3, for example).

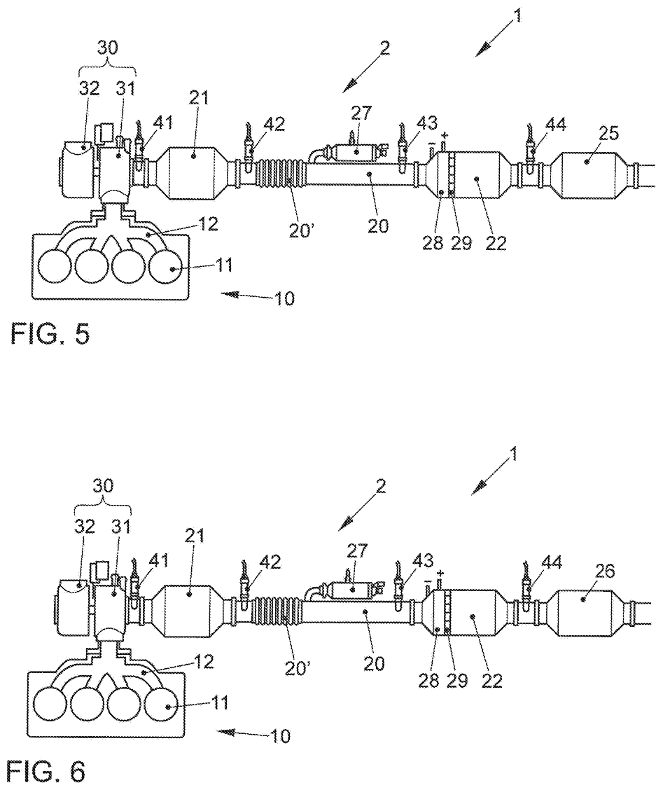

FIG. 5 shows a vehicle 1 having an internal combustion engine 10 and an exhaust gas system 2 connected thereto according to a fifth embodiment of the invention, wherein identical components are denoted by the same reference numerals as in FIG. 1 and are not explained again. The exhaust gas system 2 shown in FIG. 5 differs from FIG. 1 in that a further three-way catalytic converter 25 for converting HC, CO, and NOₓ is situated at an underbody position of the vehicle downstream from the electrically heated exhaust emission control device 22. In addition, the fourth lambda sensor 44, instead of being situated in the heated exhaust emission control device 22, is situated downstream therefrom and upstream from the three-way catalytic converter 25 farthest downstream. The design according to FIG. 5 allows extremely high conversion power and stability, even under high loads and high space velocities of the exhaust gas stream.

FIG. 6 shows a vehicle 1 having an internal combustion engine 10 and an exhaust gas system 2 connected thereto according to a sixth embodiment of the invention, wherein identical components are denoted by the same reference numerals as in FIG. 1 and are not explained again. The exhaust gas system 2 shown in FIG. 6 differs from FIG. 1 in that a four-way catalytic converter 26, i.e., a three-way catalytically coated particulate filter for converting HC, CO, and NOₓ and for retaining particles, is situated at an underbody position of the vehicle downstream from the electrically heated exhaust emission control device 22. In addition, the fourth lambda sensor 44, the same as in FIG. 5, instead of being situated in the heated exhaust emission control device 22, is situated downstream therefrom and upstream from the four-way catalytic converter 25 farthest downstream. The design according to FIG. 6, in addition to the high conversion power and stability, also allows reduction of particulate emissions.

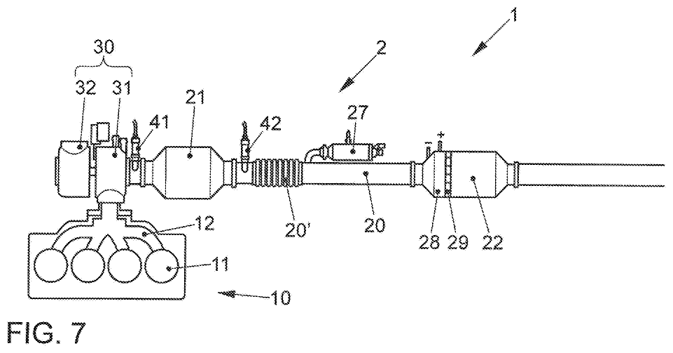

FIG. 7 shows a vehicle 1 having an internal combustion engine 10 and an exhaust gas system 2 connected thereto according to a seventh embodiment of the invention, wherein identical components are denoted by the same reference numerals as in FIG. 1 and are not explained again. The exhaust gas system 2 shown in FIG. 7 differs from FIG. 1 in that the third lambda sensor 43 situated upstream from the heated exhaust emission control device 22 is omitted. This design is thus less costly, although it is subject to lower control dynamics.

Various aspects of the embodiments described above by way of example may also be combined with one another. Thus, the selection and arrangement of the lambda sensors may be varied in all designs; for example, the third lambda sensor 43 may be omitted, as shown in FIG. 7.

### LIST OF REFERENCE SYMBOLS

1 vehicle

10 internal combustion engine, gasoline engine

11 cylinder

12 exhaust manifold

2 exhaust gas system

20 exhaust duct

20′ connecting piece

21 first exhaust emission control device, three-way catalytic converter

22 second exhaust emission control device, three-way catalytic converter

23 first exhaust emission control device, four-way catalytic converter

24 gasoline engine particulate filter

25 three-way catalytic converter

26 four-way catalytic converter

27 burner

28 electric heating device, heating disc

29 support pins

30 exhaust gas turbocharger (ATL)

31 exhaust gas turbine

32 compressor

41 measuring device for measuring an oxygen content of the exhaust gas, lambda sensor

42 measuring device for measuring an oxygen content of the exhaust gas, lambda sensor

43 measuring device for measuring an oxygen content of the exhaust gas, lambda sensor

44 measuring device for measuring an oxygen content of the exhaust gas, lambda sensor

λₑ lambda value for the internal combustion engine, internal combustion engine lambda value

λ_{b} lambda value for the burner

λₘ lambda value for the mixed gas

1. An exhaust gas system for an internal combustion engine, comprising:
a first exhaust emission control device through which an exhaust gas of the internal combustion engine may flow,
a second exhaust emission control device, situated in a flow path of the exhaust gas downstream from the first exhaust emission control device, through which exhaust gas may flow, the second exhaust emission control device having an electric heating device for heating the second exhaust emission control device, and
a burner, situated in the exhaust gas flow path downstream from the first exhaust emission control device and upstream from the second exhaust emission control device, that is configured for being operated with a fuel and an oxidative gas stream in order to heat the gas stream by combustion of the fuel and supplying it to the second exhaust emission control device.

2. The exhaust gas system according to claim 1, wherein the first exhaust emission control device is situated at a position close to the engine, in such a way that an exhaust gas path length between a cylinder outlet of the internal combustion engine and an entry surface of the first exhaust emission control device is at most 50 cm.

3. The exhaust gas system according to claim 1, wherein the second exhaust emission control device is situated at an underbody position remote from the engine, in such a way that an exhaust gas path length between acylinder outlet of the internal combustion engine and an entry surface into the second exhaust emission control device is at least 80 cm.

4. The exhaust gas system according to claim 1, wherein the first exhaust emission control device is a three-way catalytic converter or a four-way catalytic converter.

5. The exhaust gas system according to claim 1, wherein the second exhaust emission control device is a three-way catalytic converter.

6. The exhaust gas system according to claim 1, further comprising:
a measuring device, situated upstream from the first exhaust emission control device, for measuring an oxygen content of the exhaust gas and/or
a measuring device, situated downstream from the first exhaust emission control device and downstream from the burner, for measuring an oxygen content of the exhaust gas.

7. The exhaust gas system according to claim 1, further comprising a measuring device, situated downstream from the burner and upstream from the second exhaust emission control device, for measuring an oxygen content of the exhaust gas, and/or a measuring device, situated downstream from or in the second exhaust emission control device, for measuring an oxygen content of the exhaust gas.

8. The exhaust gas system according to claim 1, wherein the electric heating device of the second exhaust emission control device has a heating disc through which the exhaust gas may flow.

9. The exhaust gas system according to claim 1, further comprising a particulate filter that is situated downstream from the first or the second exhaust emission control device.

10. The exhaust gas system according to claim 1, further comprising a three-way catalytic converter that is situated downstream from the second exhaust emission control device.

11. The exhaust gas system according to claim 1, further comprising a four-way catalytic converter that is situated downstream from the second exhaust emission control device.

12. A method for operating an exhaust gas system according to claim 1 when a low-temperature state is present, comprising the steps of:
operating the internal combustion engine using at least one engine-internal measure for raising the exhaust gas temperature, and
activating the burner and the electric heating device of the second exhaust emission control device at the same time or offset in time,
wherein the internal combustion engine and the burner are each operated with a lambda value in such a way that a mixed gas entering the second exhaust emission control device is stoichiometrically 1.

13. The method according to claim 12, wherein the internal combustion engine and the burner are each operated with a stoichiometric lambda value.

14. The method according to claim 12, wherein the internal combustion engine is operated with a rich lambda value, and wherein the burner is operated with a lean lambda value in such a way that the mixed gas is stoichiometric.
